(19) United States
(12) Patent Application Publication
(10) Pub. No.: US 2010/0284863 A1
(43) Pub. Date: Nov. 11, 2010

(54) BIOSENSOR CARTRIDGE AND BIOSENSOR MOUNTING SYSTEM WITH INTEGRAL FLUID STORAGE AND FLUID SELECTION MECHANISMS

(76) Inventors: James G. Downward, Ann Arbor, MI (US); Judith L. Erb, Ann Arbor, MI (US); Daniel P. Schmidt, Dexter, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/049,934

(22) Filed: Mar. 17, 2008

Related U.S. Application Data
(60) Provisional application No. 60/895,293, filed on Mar. 16, 2007.

(51) Int. Cl. G01N 21/63

(52) U.S. Cl. 422/82.08; 422/82.05

(57) ABSTRACT

Some embodiments of the invention comprise a biosensor cartridge which optically, fluidically, and/or mechanically couples to an evanescent sensing measurement apparatus having annularizing illumination elements, said biosensor cartridge and measurement apparatus being used for detecting the presence of chemically or biologically active substances binding to said biosensor present within an aqueous media, such as and without limitation, the presence of specific proteins in blood or urine. Some embodiments comprise an integrated biosensor cartridge having a flow channel and a plurality of storage cavities, fluid flow in the cartridge controlled by valving mechanisms for directing a plurality of fluids through the cartridge, the order and amounts of such fluids passing through the cartridge being externally controlled and required for the detection and measurement of specific chemically or biologically active substances.

### CROSS-REFERENCE TO RELATED APPLICATIONS

This application claims priority from U.S. Provisional Patent Application Ser. No. 60/895,293, filed Mar. 16, 2007, which is hereby incorporated in full into this application.

### FIELD OF THE INVENTION

The invention relates to the field of devices for the measurement of analytes, including but not limited to, analytes in chemical or biological samples.

### BACKGROUND

There is continued and growing interest in rapid, sensitive, and repeatable detection and measurement of analytes of interest in samples, including in chemical and biological samples. The interest originates from diverse sources, including among them, the desire to screen quickly for pathogens, for molecules of interest in chemical and biological processes, for molecules having medical diagnostic relevance, and for analytes of interest for homeland defense purposes.

One generally known screening technique involves the use of evanescent fiber-optic sensor techniques. Such techniques often involve a method of selective immobilization of an analyte of interest on an assay surface, accompanied by qualitative and/or quantitative measurement of the analyte by fluorometric or other means.

While a variety of evanescent fiber-optic sensor techniques are known in the art, there remains a need for apparatus, methods and systems that permit rapid, sensitive, and repeatable detection and measurement of analytes of interests while reducing operator time, effort, or error in the management and processing of samples.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 shows top and side schematic views of features of an evanescent sensing measurement system in accordance with some embodiments of the invention.

FIG. 2 shows top and side views illustrating the process by which an evanescent sensing measurement system achieves an annularized excitation beam at or near the proper numerical aperture (“NA”) for an optical fiber in the medium of a sample.

FIG. 3 is a representation of annularization of a light beam within an optical fiber which is subsequently coupled to an embodiment of the biosensor cartridge of the present invention.

FIG. 4 shows an embodiment of a biosensor cartridge.

FIG. 5 shows a front cross sectional view of a capillary coupling mechanism.

FIG. 6 shows views of a biosensor cartridge which allows rapid coupling of a biosensor cartridge to an evanescent sensing measurement apparatus in accordance with some embodiments.

FIG. 7 shows a cross section of a fluid collet according to some embodiments.

FIG. 8 shows a cross section of mounting and coupling a biosensor cartridge with other aspects of an evanescent sensing measurement system according to some embodiments.

FIG. 9 shows a cross section of a biosensor cartridge according to some embodiments.

FIG. 10 is an expanded view of the optical fiber of a biosensor cartridge in accordance with some embodiments.

FIG. 11 is an exploded view of a biosensor cartridge attached to a disposable sample holder/reagent pac.

FIG. 12 is an exploded view of a biosensor cartridge and attached disposable sample holder/reagent pac connected to an evanescent sensing measurement apparatus.

FIG. 13 is a representation of an integrated biosensor cartridge having a plurality of fluid storage cavities and a fluid valving mechanism according to some embodiments.

Other aspects of the invention will be apparent to those skilled in the art after reviewing the detailed description below.

### DETAILED DESCRIPTION

The following description of some embodiments of the invention is provided without limiting the invention to only those embodiments described herein and without disclaiming any other embodiments.

Some embodiments comprise a biosensor cartridge having optical fiber disposed at least in part within a flow channel, forming a chamber between an outer surface of the optical fiber and an internal surface of the flow channel; a proximal end coupling region configured to couple the optical fiber to an evanescent sensing measurement apparatus having annularizing illumination elements; a fluid ferrule joined to the proximal end of the flow channel; and an inlet tube joined to the distal end of the optical fiber and to the internal surface at the distal end of the flow channel. The optical fiber has a proximal end support region and a distal end support region each comprising a low index cladding disposed in a protective sheath, and a chemically sensitized region free of such cladding which is disposed between the proximal end support region and the distal end support region. The proximal end support region is disposed at least in part within the fluid ferrule. The inlet tube is configured to center the optical fiber within the flow channel, and the inlet tube and the fluid ferrule are configured to allow one or more liquids to be drawn up through the inlet tube, the chamber, and the fluid ferrule.

Additional embodiments comprise a biosensor cartridge system having a cylindrical cartridge comprised of a plurality of cavities for containing fluids surrounding a central open core, each of the cavities having an outlet port, a selector valve having an inlet port and an outlet port, and biosensor cartridge as described herein, wherein the distal inlet tube of the biosensor cartridge is configured to insert within the central open core of the generally cylindrical cartridge and connect to the outlet port of the selector valve, the input port of the selector valve further configured to communicate selectively by its input port with any of the outlet ports of the cavities.

Some embodiments comprise an integrated biosensor cartridge with a flow channel containing a chemical sensitized region of an optic fiber configured to couple to annularizing illumination elements of an evanescent sensing measurement apparatus, one or more valving mechanisms selectively in fluid communication with the flow channel, and a plurality of cavities for containing fluids which are selectively in fluid communication with one or more of the valving mechanisms.

Moreover, additional embodiments comprise a system for an analyte in a sample, having an evanescent sensing measurement apparatus with annularizing illumination elements; a biosensor cartridge comprised of an optical fiber disposed at least in part within a flow channel, forming a chamber between an outer surface of the optical fiber and an internal surface of the flow channel, a proximal end coupling region configured to couple the optical fiber to a an evanescent sensing measurement apparatus having annularizing illumination elements, a first fluid port joined to the proximal end of the flow channel; and a second fluid port joined to the distal end of the optical fiber and to the internal surface at the distal end of the flow channel, wherein the optical fiber has a proximal end support region and a distal end support region each comprising a low index cladding disposed in a protective sheath, and a chemically sensitized region free of such cladding which is disposed between the proximal end support region and the distal end support region. The proximal end support region is configured to center the optical fiber within the flow channel is disposed at least in part adjacent to the first fluid port, and the distal end support region is also configured to center the optical fiber within the flow channel. The first fluid port and the second fluid port are configured to allow liquid to be drawn up through the first fluid port, the chamber, and the second fluid port; one or more valving mechanisms selectively in fluid communication with the flow channel; and a plurality of cavities for containing fluids which are selectively in fluid communication with one or more of the valving mechanisms. The selective communication of one or more valving mechanisms with the flow channel and of the plurality of cavities for containing fluids with one or more of the valving mechanisms is controlled by a microprocessor.

Embodiments of the invention also comprise apparatus, methods, and systems which have a biosensor cartridge and a combined sample cup and reagent pac that mates to the inlet port of the biosensor cartridge. Embodiments of the invention also comprise a device with computer control to identify the reagent pack and biosensor being used and to select which fluid is drawn up through the biosensor inlet port. Some embodiments may also comprise biosensor cartridges with printed or otherwise embedded or attached identifying and/or control information, readable and utilized by a control program of the evanescent sensing measurement apparatus to control one or more of fluid flow, timing, or other control process.

In some embodiments, the invention comprises a biosensor cartridge which is optically, mechanically, and/or fluidically coupled to an evanescent sensing measurement apparatus with annularizing illumination elements, the biosensor cartridge and measurement apparatus being used for detecting the presence of chemically or biologically active substances binding to the biosensor cartridge present within an aqueous media, such as and without limitation, the presence of specific proteins in blood or urine. Thus, some embodiments comprise a biosensor cartridge for use with an evanescent sensing measurement apparatus with a flow channel containing a chemically sensitized optical fiber region and optically coupling to the annularizing illumination elements of the measurement apparatus. In another embodiment, a flow region is contained within a biosensor cartridge which provides one or more valving mechanisms for directing one or more fluids through the cartridge, the order and amounts of such fluids passing through the cartridge controlled by a microprocessor and used for the detection and/or measurement of specific chemically or biologically active substances.

Some embodiments of the invention comprise a biosensor cartridge containing a chemically sensitized optical fiber for use with an optical measurement device employing an annularizing illumination system and which is provided with improved features for optically, mechanically, and/or fluidically coupling with the said optical measurement device. Some embodiments of the invention also comprise a biosensor cartridge which has a plurality of storage cavities for fluids, including but not limited to, reagents or samples, which are used in making measurements with the biosensor cartridge. Other embodiments comprise a biosensor cartridge with waste storage cavities for holding waste fluid after such fluid is utilized in the biosensor cartridge, and/or a biosensor cartridge incorporating a plurality of valve mechanisms for directing the flow of fluids in a user-determined order from and between the fluid storage cavities, past said biosensor sensing surface, and into a waste disposal cavity.

Biosensor cartridges comprising some embodiments of the present invention represent an improvement over the prior art of evanescent sensing in several regards, among others. First, novel cartridge geometries and cartridge mounting systems permit cartridge insertion into a measurement instrument to automatically optically, mechanically, and/or fluidically align and couple with minimal loss the optical sensor fiber to an external annularizing illumination and optical detection system while simultaneously fluidically coupling the cartridge body to a fluid control subsystem. Second, due to a protective sheath at each fiber sensor end, the biosensor fiber and the optical fiber protruding from the proximal end of the biosensor cartridge permit optically and/or physically coupling the proximal end with minimal signal loss to an external annularizing illumination and optical detection system. Third, due to the protective sheath at each of its ends, the biosensor cartridge can be sealed within additional biosensor cartridge designs using a variety of methods, but not limited to gluing or molding. Fourth, because said protective sheaths are present at both ends of the biosensor fibers, the biosensor fibers may be accurately located, without touching walls, at the center of extremely narrow biosensor cartridge flow channels having gaps between biosensor surface and channel wall as low as at least 50-150 μm. Moreover, in some embodiments, the biosensor cartridge provides a unitary device with a plurality of chambers for waste and reagent storage and a plurality of valving means under external control for performing a wide variety of different measurements.

An important feature of an evanescent biosensor is confinement of the measurement area to the surface of the waveguide by taking advantage of the evanescent field associated with total internal reflection within the fiber. The manner in which this functions is as follows.

Consider light incident at angle θ on the boundary between two optical media with indexes of refraction N and n (N>n). When the light is incident on the boundary at angles greater than or equal to the critical angle θ_{crit} where sin(θ_{crit})=n/N, the light will be totally reflected from the surface. Although, light is not transmitted past the boundary and into the media with the lower index of refraction, electromagnetic theory shows that an evanescent electromagnetic field decays exponentially with perpendicular distance from the boundary. The characteristic 1/e depth of this decay for light of wavelength λ incident at angle θ is given by the equation:

(λ/4π)(N² sin² θ−n²)^{-1/2}. [Equation 1]

This distance is large compared with the dimensions of proteins and biologically significant nucleotides. Thus, the light with wavelength λ₁ will interact with fluorescent molecules, which are associated with any proteins or nucleotides that are attached near the probe's surface, to generate fluorescence at wavelength λ₂. Because the waveguide is very large compared with the size of the proteins or nucleotides, a large fraction of the emitted fluorescence light at wavelength λ₂ will intersect the fiber optic sensor, then be trapped inside due to total internal reflection, and finally be carried back to a solid state light detector in the control unit of the measurement apparatus.

Early designs of evanescent sensing instruments achieved delivery of excitation light to and collection of fluorescence from the sensor fiber by means of free space propagation from a focusing lens into the fiber sensing element without the use of an intermediate low loss beam shaping means. See e.g., U.S. Pat. No. 4,447,546.

However, shaping of the entering excitation light into an annular beam is described in U.S. Pat. No. 5,854,863, which describes injection of annularized light at or near the critical angle. This provides greater detection sensitivity than previous devices by injecting the light into the biosensor using an annularizing means to concentrate light entering the biosensor at the critical angle for optimally stimulating fluorescence from evanescently stimulated fluorescent tags which bind to the biosensor surface.

Nonetheless, with many cartridges having an evanescent fiber optic sensor, light is lost from the fiber sensor at any point of contact which has a higher refractive index than that of the sample. Some previous efforts to deal with this problem have been described but have proven inadequate. For example, U.S. Pat. No. 4,447,546 discloses holding the fiber in place using a supporting stopper out of siloxane and coating the ends of the fiber with a low refractive index silicone. However, this does not fully solve the problem because the refractive index of silicones and siloxanes is at best 1.367. By comparison, a fiber in an aqueous solution having refractive index of 1.33 creates an NA, of about 30.1°. Thus the light near the critical angle of 35.8° will be lost in the siloxane. Another method for attempting to deal with the problem of light loss due to improper matching of NA, is disclosed in U.S. Pat. No. 5,061,857. There the sensor fiber is tapered so as to produce a transformation of the effective NA of the fiber. However, the fiber is etched in hydrofluoric acid to achieve correct tapering, creating problems with respect to manufacturability. U.S. Pat. No. 4,671,938 discloses another method for avoiding light loss where the fiber contacts a support. There the sensor fiber is held at its distal end, but not at its proximal end, thereby avoiding the issue of contact with the supporting structure. However, in this method, the direct injection of annularized light at or near the critical angle cannot be accomplished because the method precludes inserting the proximal end of the sensor fiber into the coupling capillary containing the annularizing fiber.

However, such problems with light loss are mitigated by using the optical measurement apparatus and biosensor fabrication method according to U.S. Pat. Nos. 5,854,863 and 6,251,688, issued to some of the present inventors. Those patents disclose achieving greater detection sensitivity than previous devices by injecting the light into the biosensor using an annularizing means to concentrate light entering the biosensor at the critical angle for optimally stimulating fluorescence from evanescently stimulated fluorescent tags which bind to the biosensor surface. They also describe a method by which a fiber optic sensor can be mounted so as to avoid optical loses while being held in position to receive light from an annularizing fiber. This provides greater measurement sensitivity by teaching how to minimize optical losses introduced by mounting the biosensor using a layered support structure in which a mounting sheath surrounds a fiber biosensor polymer cladding in direct contact with the fiber silica surface, the low index cladding having an optical index less than or equal to that of the aqueous media within which the biosensor is to be placed. Such a low-index cladding material may be, for example and without limitation, an amorphous copolymers of tetrafluoroethylene and bis-2,2-trifluoromethyl-4,5-difluoro-1,2-dioxole, e.g. TEFLON AF®, and optical silica fibers clad with said material may be obtained from suppliers such as but not limited to Polymicro Technologies, Inc., 18019 N. 25th Ave., Phoenix, Ariz. 85023. Because of the low index of refraction of this material, the numerical aperture of a fiber clad with Teflon AF® is nearly identical to the numerical aperture of a bare silica fiber immersed in aqueous media.

To manufacture biosensors using such material, protective sheaths are first shrunk onto both the proximal and distal end of each biosensor fiber at locations where the biosensor will be supported by an external structure. Because the Teflon AF® cladding lies under the protective sheath, the biosensor may be held by those external structures touching the protective sheath without causing light loss either entering or leaving the biosensor fiber. Thereafter, the Teflon AF® cladding present in the middle of the biosensor fiber (between the distal and proximal sheaths) is chemically removed to create a bare silica surface which may be subsequently chemically cleaned and sensitized to create a biosensor surface for detecting one or more chemical moieties or biomolecules.

However, some methods described before U.S. Pat. No. 6,251,688 require that each sensor cartridge be manually aligned with the light from the focusing lens by adjustment mechanisms such as x,y,z stages upon which the biosensor cartridge is mounted or adjustment of the focusing lens. This requirement is not well adapted for use of the instrument by untrained personnel. Although U.S. Pat. No. 6,251,688 provides for a capillary which guides the proximal end of the sensor fiber and the annularizing fiber into a butt-coupled position, a difficulty arising even from this solution is damage to the face of the annularizing fiber with repeated butt-coupling operations.

Embodiments of the present invention address these problems by providing a method of reducing the stress on the annularizing fiber, thereby prolonging its lifetime. Further, embodiments of the present invention facilitate the practical use of such biosensor fibers by incorporating them into biosensor cartridges which provide novel and improved methods for optically, mechanically, and/or fluidically coupling to optical measurement devices having annularizing illumination elements. Some embodiments also provide a plurality of cavities, fluid channels, and valving mechanisms for utilizing biosensor fibers for the detecting and/or measurement of chemical and biological compounds in samples which may be drawn or inserted into a biosensor cartridge.

Thus, in some embodiments, without limitation, the invention comprises apparatus, methods, and systems for measurement of one or more analytes of interest. In some of such embodiments, a novel and improved biosensor cartridge and biosensor cartridge mounting system is provided, with capabilities for integral reagent storage and fluid selection usable as part of an optical apparatus for making measurements using an evanescent sensor contained within the biosensor cartridge.

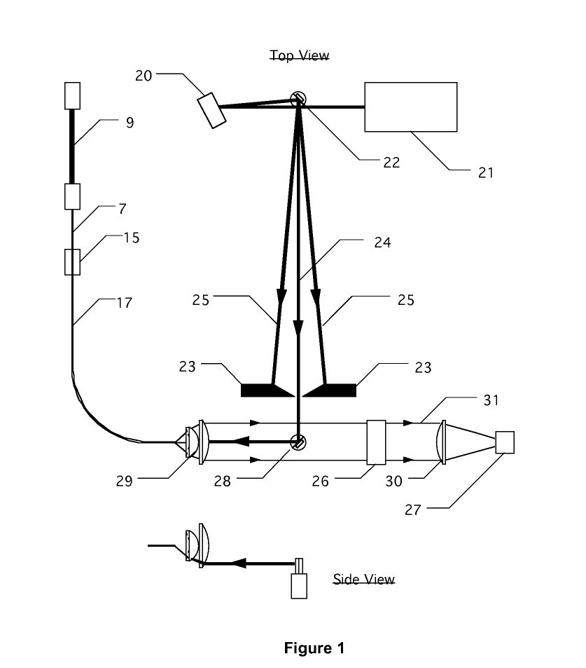

As shown in FIG. 1, in accordance with some embodiments, light from a light source (21), such as and without limitation, a laser diode, is directed to a dispersive element (20), such as and without limitation, a diffraction grating, situated such that light propagating from said light source impinges upon said dispersive element. For example, this dispersive element may be a diffraction grating in near Littrow configuration. Upon exiting from the dispersive element, the light propagates so that each constituent wavelength component of light is angularly dispersed as a function of wavelength. The dispersive element angularly separates unwanted wavelength band(s) from wanted wavelength band(s) and directs all wavelengths to a means (22), such as a turning mirror, for directing the angularly dispersed light along a path having sufficient length to spatially separate unwanted wavelength band(s) (25) from wanted wavelength band(s) (24). Blocking element(s) (23) intercept only unwanted wavelength bands (25). Selected wavelength bands (24) continue to propagate. This arrangement provides a more complete separation between light generated by the excitation source and light generated from fluorescence resulting from the binding of a solution component to the sensitized optical fiber. As a result, this design lowers background readings resulting from propagation of laser side bands which reflect back from the sensor (9), pass through filter (26), and are detected by the photodetector (27).

The selected wavelength band(s) (24) are directed by a means (28), such as a beam splitter, a prism or a partially reflective mirror, to pass off-axis through a focusing means (29) so as to enter an input face of an annularizing optical fiber (17) as a narrow beam both off-axis and at a specific injection angle to the optical axis so that the beam will first propagate as real skew modes in a substantially confined manner within the annularizing optical fiber (17). The light is thus uniformly distributed into a narrow annular band propagating at a specified angle within the annularizing optical fiber (17) and subsequently leaving the first annularizing fiber section and entering into a second fiber section (7) contained within the biosensor cartridge (9). At least a portion of this fiber section has been sensitized to substantially react with test and reagent solution(s) only in the presence of a specific chemical. The focusing means must possess a numerical aperture high enough to match that of annularizing fiber (17).

Excitation light passes through a biosensor cartridge (9) at angles at or near the critical angle, creating an evanescent field which excites fluorescent molecules which are bound to the surface of the biosensor fiber. Fluorescence from the molecules bound to the biosensor fiber surface is evanescently emitted back into confined propagating modes of the biosensor fiber, traveling back through coupling capillary (15), annularizing fiber (17), and focusing means (29). Light of wavelength at or near the excitation wavelength is blocked by a band stop filter (26), while light of wavelengths corresponding to fluorescence of molecules bound to the surface of said biosensor fiber passes through band stop filter (26) and is focused by a means (30) into an optical detector (27).

The annularizing fiber (17) provides methods and elements by which excitation light may be shaped to present light to the fiber sensor in the form of an annular ring at or near the critical angle of the sensor. The fiber assembly (7) of biosensor cartridge (9) is butt coupled to the annularizing fiber (17) by use of a coupling capillary (15). Typically, the annularizing fiber is of about the same diameter and numerical aperture as the fiber used to fabricate the biosensor fiber, for example, the annularizing fiber (17) could a 400 μm fused silica multimode fiber clad with amorphous copolymers of perfluoro (2,2-dimethyl-1,3 dioxiole) and tetrafluoroethylene (e.g. Teflon AF™). In the prior art, this coupling capillary is fixed in position and provides no cushioning of the butt-coupling action. The current invention provides a mounting by which the coupling capillary floats and cushions the coupling action, thereby reducing damage to the annularizing fiber.

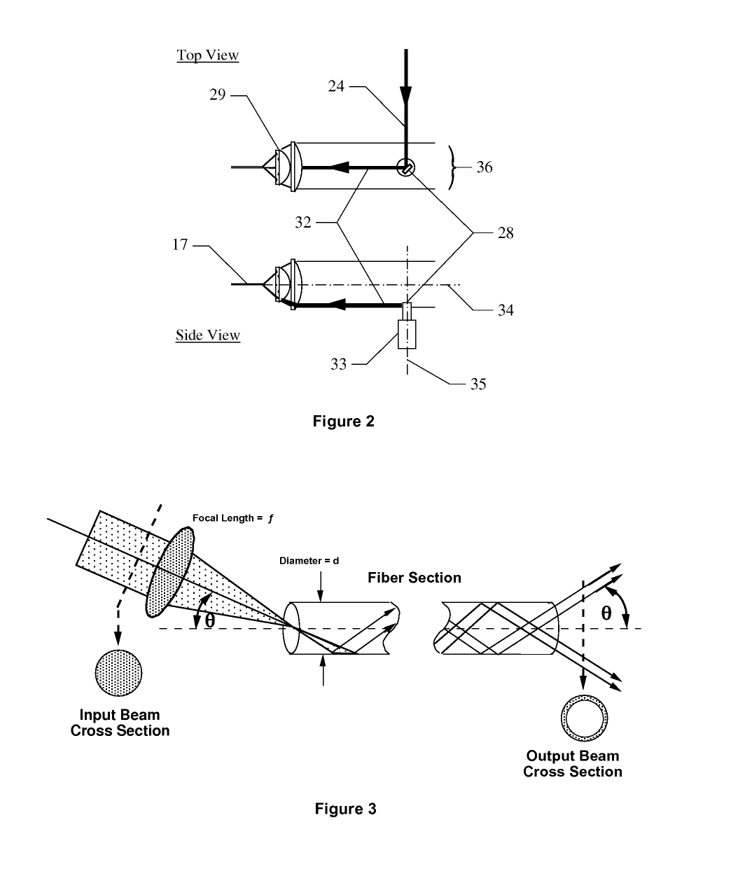

FIG. 2 shows the manner by which the annular excitation beam of the desired angular distribution is created. An optical axis (34) is established by the position of an injection lens system (29) and an optical fiber (17) with its proximal end near the focal spot of the lens system. A light beam (24) is propagated to intersect the projected aperture (36) of the system on the side opposite from said optical fiber. In some embodiments, the light beam (24) propagates at an angle substantially perpendicular and skew to the optical axis (34). A redirecting axis (35) is established, which is substantially perpendicular to the optical axis, about which a redirecting element (28) may rotate. Here the redirecting axis intersects with the optical axis. The redirecting element (28) is positioned to intercept and redirect the light beam (24) at an angle substantially parallel to the optical axis. The redirecting element (28) may be translated along the redirecting axis (35) so that it protrudes into the projected aperture by an amount just sufficient to intercept the light beam, with all of its mounting and manipulating apparatus (33) exterior to the projected aperture. The light beam may be translated perpendicular to the redirecting axis by an external means, while maintaining interception by concomitant translation of the redirecting element, to affect a change in the perpendicular distance of the redirected beam (32) relative to the optical axis, thereby affecting the injection angle into the optical fiber. Embodiments of the redirecting element may include, without limitation, be a mirror, a prism, holographic optical element (“HOE”), or any other elements or methods whereby the beam is redirected to the appropriate angle of parallelism to the optical axis from the transverse angle of the light beam.

FIG. 3 is an example of the disposition of the ray bundle upon entering fiber (17) at angle θ. The parallel rays of light of the ray bundle have been focused by an optical element with focal length f into a section of optical fiber of diameter d. When this is done, the beam is forced to propagate through the fiber in high order off axis skew rays and is thus converted to an narrow annular cone with a half cone angle of θ at the output end of the fiber. In any plane perpendicular to the expanding cone, light radiation is concentrated in an annular ring whose thickness is determined by the initial spread in input angles induced by the focusing lens (i.e. determined by its numerical aperture (“NA”), f/#, or cone angle of the illumination lens) and by the area of inside of the fiber illuminated by the focused beam passing through the front face of the section of optical fiber. For example, as the injected beam diameter and the NA of the illumination objective are made smaller (e.g. NA<0.05), in the absence of other dispersive processes, the annular thickness or the emergent cone will become increasingly narrow and as a consequence, the angular distribution of rays which will be injected into and propagate within the sensor becomes narrowly peaked at close to the desired critical angle. On the other hand, as the NA of the illumination objective becomes larger (e.g. NA=0.3) or the diameter of the injected beam larger, the annulus will become thicker and because fewer of the ray angles emerging from the annularizer are close to the desired critical angle, the sensitivity of the evanescent fiber sensor will be reduced.

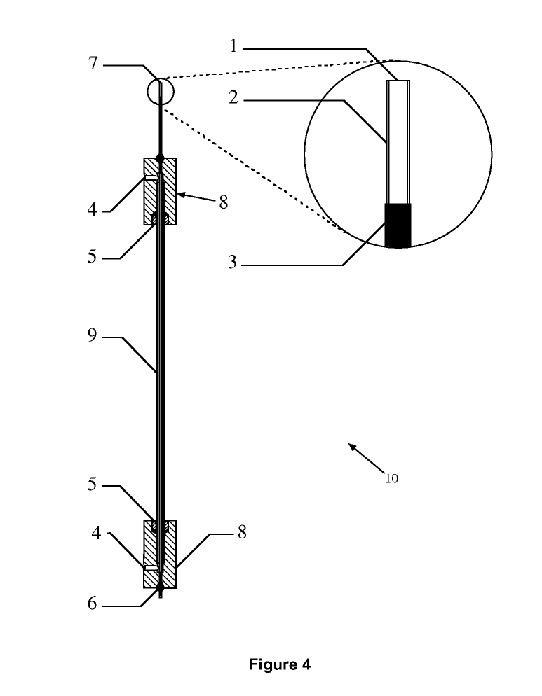

To illustrate features of an earlier biosensor cartridge design, FIG. 4 shows a biosensor cartridge (9) which is designed to receive an annular excitation beam and to propagate that beam with high efficiency so as to create an evanescent field along its length, the evanescent field exciting fluorescence in molecules which are bound to the surface of fiber assembly (7), to receive said fluorescence which is evanescently emitted back into fiber assembly (7), and to propagate said fluorescence back to annularizing fiber (17 of FIG. 1)).

Fluid ferrules (8) are disposed at each end position of an optical fiber assembly (7) which is itself within a cylindrical tube of capillary dimensions (9), allowing the fiber assembly (7) to be surrounded by the sample under test. The holes through which the optical fiber assembly (7) passes through the fluid ferrules (8) are sealed by suitable methods known to those of ordinary skill in the art, such as and without limitation, 5 Minute® epoxy, to prevent leakage of sample. The cylindrical tube of capillary dimensions (9) is seated in fluid ferrules (8) by methods known to those of ordinary skill, such as and without limitation, a captured O-ring (5) in a manner which prevents leaking of sample. The alignment of the optical fiber assembly (7) and the cylindrical tube (9) must be sufficiently centered with respect to one another along the longitudinal axis so as to prevent optical fiber assembly (7) from contacting cylindrical tube (9). Holes (4) allow sample to be brought into and out of the cylindrical tube (9).

The optical fiber assembly (7) is shown in the magnified section on the right of FIG. 4. At the center of optical fiber (7) is an optical fiber (1) which has been stripped of its cladding, treated so as to possess a network of hydrophobic regions on its surface, and chemically sensitized so as to bind a specific type of molecule. A coating (2), having refractive index lower than that of the sample solution, is applied to the longitudinal surface at both ends of fiber (1) so as to constrain light within the fiber (1) in the region where contact with other components occurs. A protective sheath (3) is disposed on at least a portion of the optical fiber (1); the sheath (3) is made of a material, such as and without limitation, polyimide tubing, which fits tightly around coating (2) and prevents mechanical abrasion of the coating (2).

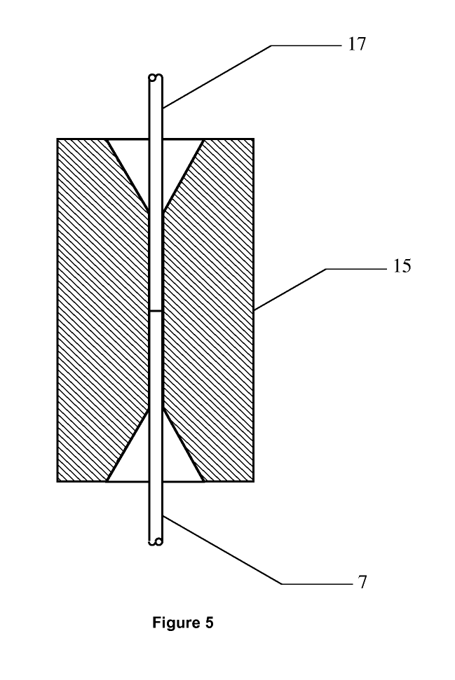

FIG. 5 shows a previous means for coupling the optical fiber assembly (7) within the biosensor cartridge to an optical excitation means, by providing a coupling capillary (15). The coupling capillary (15) provides a mechanism by which the annularizing fiber (17) is butt-coupled to optical fiber assembly (7) of the biosensor cartridge (9). In order to minimize loss of light at the point of coupling, the coating (2) on the optical fiber (1) should possess a refractive index which is essentially equivalent to that of the cladding of the annularizing fiber (17). The optical fiber assembly (7) and annularizing fiber (17) easily enter coupling capillary (15) due to beveling of the entrance holes. The diameter of the inner bore of the coupler is such that the fibers are confined in all directions so that said fibers may be precisely mated by butt-coupling. The material of the coupling capillary (15) is non-abrasive in nature so that coating (2) is not scraped off of the optical fiber assembly (7) during positioning in the coupling capillary (15).

The biosensor cartridge and coupling capillary as shown in FIG. 4 and FIG. 5 have several disadvantages. The biosensor cartridge of FIG. 4 has proven difficult to manufacture with accuracy. First, it is exceedingly difficult to connect to a fluid transfer system needed for passing liquids in and out of the biosensor cartridge because the fluid ports (4) located on each fluid ferrule (8) are difficult to align with fluid transfer connectors located on a sensor mounting apparatus as previously described in U.S. Pat. No. 6,251,688. Second, the use of O-rings to attach the fluid ferrules (8) to the capillary tubes increase manufacturing cost and do not allow the ferrules to be centered axially with the capillary tubes or allow the biosensor fibers to be centered within the capillary tubes with sufficient accuracy. Third, direct manual butt-coupling without any cushioning means during the mating of the biosensor fiber proximal face (1) to the face of the annularizing fiber (17) causes the annularizing fiber (17) face to be frequently damaged. Fourth, using such biosensor cartridges with biological samples may result in undesirable contact with the samples because the ferrules were mounted on an unsheathed, fragile glass capillary tube (9). Finally, the biosensor cartridge design taught in U.S. Pat. No. 6,251,688 does not provide for on-board storage of reagents needed for making measurements or for on-board disposal of waste.

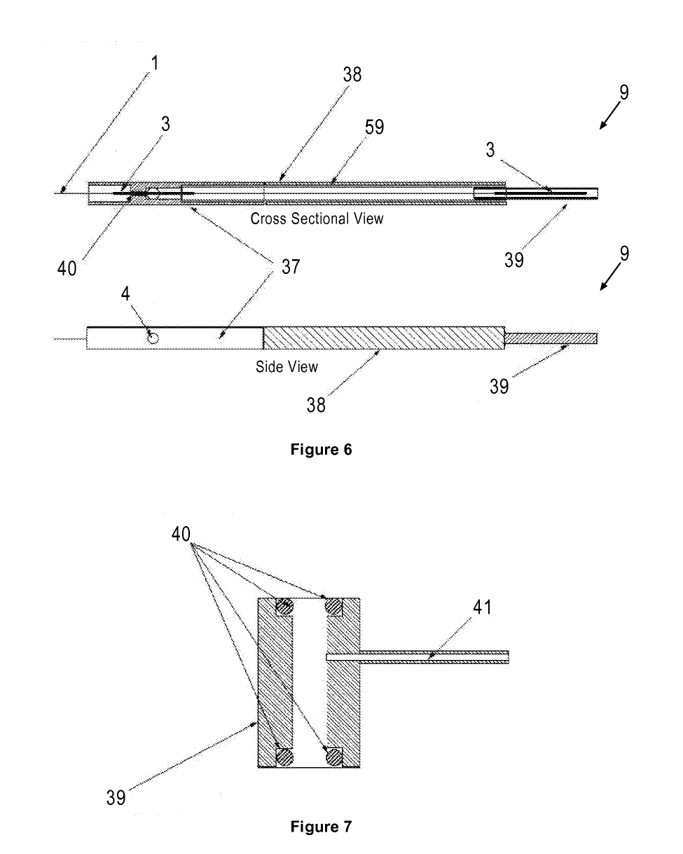

These shortcomings are addressed by embodiments of the present invention. As shown in FIG. 6, in some embodiments, a biosensor cartridge (9) is provided which incorporates a sensitized fiber-optic segment (1) within a cartridge body (38) designed to allow fluids to be drawn into an inlet tube (39), past the sensitized region of optical fiber 1, and out through an outlet port 4 and finally into a liquid waste receptacle (not shown in FIG. 6). Protective sheaths (3) are disposed on the proximal and distal ends of at least a portion of the outer surface of an optical fiber (1) having a central chemically sensitized region. The optical fiber is mounted via portions of its respective ends within a fluid ferrule (37), as one example only, of generally cylindrical shape, and a fluid inlet (39), which hold the optical fiber (1) in tightly centered position within a flow region within a flow tube (59). The proximal protective sheath (3) is positioned so as to allow the proximal end of the fiber (1) to optically couple with the annularizing illumination system (17) of an evanescent sensor measurement apparatus. The distal protective sheath (3) exceeds the length of the distal face of the biosensor fiber (1) by an amount sufficient to prevent light from escaping from the biosensor fiber (1) into the solution being measured and stimulating fluorescence or for solution from entering this closed cavity created by the resulting overhang and impinging upon the distal face of the biosensor fiber (1). Typically an overhang of 1-3 millimeters is sufficient for this purpose, although other dimensions may be used as necessary. Should greater assurance be required that the distal end of the biosensor fiber does not optically or physically communicate with the external solution being measured, a drop of opaque substance, such as, but not limited to, a black glue may be deposited in the hole at the end of the distal sheath overhang.

A fluid inlet tube (39) is affixed to the distal end of the glass capillary flow tube (59) by methods including and without limitation using glue, placing a shrink tube so that it shrinks over both the glass capillary tube (9) and the fluid inlet tube (39) or other means known to those of ordinary skill so as to center the inlet tube (39) within the flow tube (59). Care is taken to mitigate touching by the biosensor fiber surface against the inner wall of the fluid inlet (39) by positioning the distal sheath (3) to surround all regions of the sensor fiber (1) that are within the fluid inlet (39). In addition, if the inside diameter of the fluid inlet (39) is ID and if the outside diameter of the sheath covering the distal end of the biosensor fiber is OD, then (ID−OD)/2 is preferably less than the maximal allowed displacement of the biosensor in the flow tube (59).

The glass capillary flow tube (59) is disposed within an external sheath (38) so as to provide additional confinement of samples, including without limitation, biological samples used in conjunction with the biosensor cartridge. In some embodiments, the external sheath (38) may comprise a sheath formed by shrinking heat-shrink tubing around the glass capillary flow tube (59). Preferably, this sheath (38) is approximately the same diameter as the proximal fluid ferrule (37) so that the biosensor cartridge may be inserted into a biosensor cartridge mounting system,

The fluid ferrule (37) preferably is fit tightly around and seals to the flow tube (59). In some embodiments, the fluid ferrule (37) is comprised of a fluid port (4) in fluid communication with the interior of the flow tube. As shown in FIG. 7, in some embodiments, the fluid port (4) is positioned on the fluid ferrule (37) so that there are regions proximal and distal to the fluid port (4) where a fluid collet (39) with two exterior O-rings (40) can enclose the fluid port (4) of the fluid ferrule (37) and pass fluid without leaking between flow tube (59) and the fluid collet's fluid port (41). In turn, in some embodiments, the fluid part (14) is part of or connects to a fluid control system of the evanescent sensing measurement system.

The optical fiber 1 of embodiments of biosensor cartridges may be of any suitable outer diameter, although an outer diameter of about 400 μm OD silica fiber is preferred. Similarly the outside dimensions of the biosensor cartridge may be of any suitable size. As only one example, without limitation, one embodiment of the biosensor cartridge is about 120 mm long with an inlet tube at the distal end. The proximal fluid ferrule comprising a fluid outlet may be machined, as one example only, from aluminum, and anodized, or it can be molded from any suitable material. The biosensor cartridge may use a glass capillary tube with an ID of 1.2 mm and an external plastic sheath of 3M FP301 shrink tubing. Another embodiment of a biosensor cartridge for example and without limitation is approximately 65 mm long with fluid ferrules at both ends. The proximal fluid ferrule (fluid outlet) is machined from aluminum and anodized, or may be molded from any suitable material. This embodiment has a glass capillary tube with an ID of 0.7 mm and an external sheath of 3M FP301 shrink tubing. The protective sheaths on the ends of the fiber are made of polyimide or may be of any shrinkable polymer tube such as polyolefin, or could be formed by an in situ polymerization process.

Prior designs suffered from fluid leaks, difficulty of manufacturing, the inability of operators to properly mount the biosensor cartridges and mate the cartridges with an external coupler device located at a fixed position, and annularizers which would frequently shatter. For example, in previous designs, the coupling capillary was fixed in position (x, y, and z) in the mounting body, and the sensor fiber had a more elongated section protruding from the proximal end of the fiber. The purpose of the conical hole in the coupling capillary was to bring the sensor fiber into the hole where it would mate with the annularizer, typically by bending. The cartridge was to be placed on a mechanical carriage, the axis of the fiber on the carriage had to be mechanically aligned with the coupler in order for it to work. Inordinate care was required to bring the mechanical stage containing the sensor fiber into contact with the coupling capillary containing the annularizer; similarly, the annularizer often had to be inserted into the capillary only after the sensor cartridge was fixed in place. Sliding the mechanical carriage into position by hand frequently shattered the face of the annularizing fiber, and maintaining an alignment tolerance of 25 microns over time was difficult to achieve. Coupling the cartridge's small fluid ports to the external fluidic system (consisiting of small tubes and O-rings) was also operator-intensive, time-consuming, and often inaccurate.

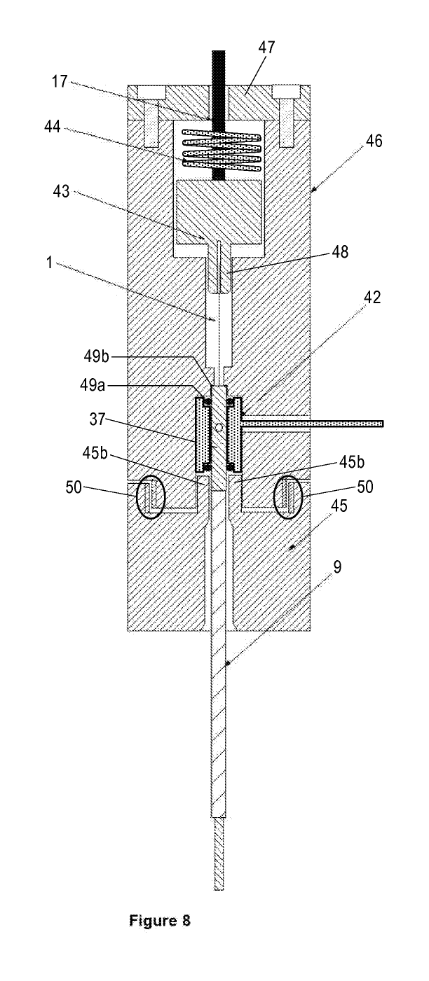

Embodiments of the present invention address these problems of previous designs. In some embodiments, without limitation, a sheathed biosensor cartridge (9) is approximately 2.1 mm in diameter and 103 mm long exclusive of the protruding sheathed sensor fiber (1). As illustrated in FIG. 8, this biosensor cartridge (9) is inserted into the body (46) of a biosensor mounting system through a central hole in the biosensor clamp (45) which about 2.2 mm in diameter.

Some embodiments comprise a biosensor mounting system for joining the biosensor fiber 1 to the annularizer elements of an evanescent sensor measurement system. As shown in the embodiment of FIG. 8, without limitation, a biosensor mounting system is comprised of a mounting body (46), a coupling capillary (43), a fluid collet (42), and a clamp (45). The mounting body has a removable cap (47) and a central lumen of varying diameter. An annularizing fiber (17) is inserted through an opening in the cap (47) and through a spring (44). The annularizing fiber (17) is joined to the coupling capillary (43) by suitable means. As one example only, the end of the annularizing fiber (17) is disposed at least in part in a stainless steel sheath (not shown), which is then joined and held in place on the end of the annularizing fiber (17) by plastic shrink tubing. So inserted, the annularizing fiber (17) is inserted through the spring (44) into a channel (not shown) in the coupling capillary (43) and locked in place by a suitable method, for example, by locking screws which are set against the steel sheath on the end of the annularizing fiber (17).

The coupling capillary (43) now joined to the annularizing fiber (17) is inserted into a chamber of the lumen of the mounting body (46), and the removable cap (47) is joined to the mounting body (46), as one example only, by removable bolts. In some embodiments, the side tolerance between the coupling capillary (43) and the chamber of the mounting body (46) is about 1 mm, and the coupling capillary (43) has a nipple (48) which extends from a stepped surface of the coupling capillary (43) further into the central lumen of the mounting body (46).

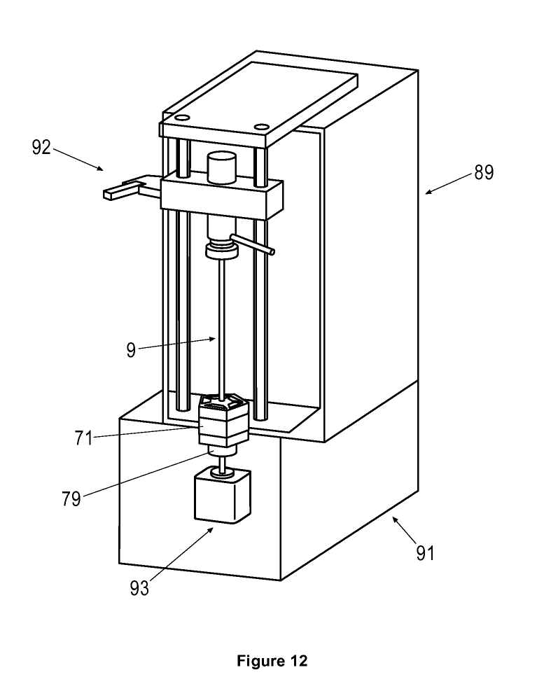

A fluid collet (42) as described herein is inserted into the other end of the central lumen of the mounting body (46) until the fluid collet (42) is stopped by a step (49a) in the central lumen. In some embodiments, the mounting body (46) has an external slit (not shown) running from its end through which the fluid collet (42) with a fluid port (41) may be inserted. The end of the mounting body (46) through which the fluid collet (42) is inserted is configured to join operably with a clamp (45) having a central lumen, for example, by corresponding threads (50) which allowed the clamp (45) to be adjusted to different positions in relation to the mounting body (46). The biosensor mounting system is then removably attached to the evanescent sensor measurement system by suitable methods, as one example only, by being held fixedly in place during operations by a clamping mechanism (92), as shown in FIG. 12.

As one example, without limitation, of mounting a biosensor cartridge (9) in accordance with embodiments of the invention, the proximal end of a biosensor cartridge (9) with an optical fiber (7) and a fluid ferrule (37) is inserted through the central lumen of the clamp (45) and the fluid collet (37) until the fluid ferrule (37) contacts a step (49b) in the central lumen of the mounting body (46) created by a decrease in the lumen's diameter compared to the diameter of the fluid ferrule (37). As the biosensor cartridge (9) is inserted, the proximal face of the optical fiber (1) travels through the mounting body (46) and into a lumen in the coupling capillary (43) until it contacts the corresponding face of the annularizing fiber (17). Because at this stage of operation the coupling capillary (43) floats in the chamber of the mounting body (46), contact of the proximal end face of the optical fiber (1) with the annularizing fiber (17) may displaced the coupling capillary (43), thus absorbing energy that might otherwise damage to annularizing fiber (17). The clamp (45) is then operably tightened against the mounting body (46) by turning the clamp (45) by suitable methods. As the clamp (45) is turned inwardly, extensions (45b) on the clamp (45) in the central lumen apply force to compress the O-rings (40) of the fluid collet (37), creating a leak-free seal between the fluid ferrule (37) and the fluid collet (42), as well as locking the biosensor cartridge (9) in place. In addition, as the clamp (45) is tightened, the spring (44) contacts respective corresponding surfaces of the cap (47) and the coupling capillary (43), applying accommodating compliant force accordingly to couple the optical fiber (1) and the annularizing fiber (17).

The overall outside dimensions and material of the cartridge mounting device (46) are not critical. As some examples of each, without limitation, in some embodiments, the cartridge mounting device may be machined or molded from a material such as, but not limited to, Delrin® or any other suitable material capable of holding necessary dimensional tolerances. Similarly, the outside diameter of the mounting body (46) is approximately 25.3 mm and its overall length is approximately 86 mm. The fluid collet (42) is insertable within the mounting body (46) may be fabricated from a material such as, but not limited to, aluminum.

The O-rings (40) of some embodiments act both as fluid sealing means and as clamping means. After the biosensor cartridge (9) is inserted, the clamp (45) is tightened thus compressing O-rings (40) at both the top and bottom of the fluid collet (42) and locking the sensor cartridge firmly within the body (46) of the biosensor mounting system and providing a leak-free fluid path for fluids to be passed through the biosensor cartridge.

The top half of the mounting body (46) contains a cylindrical chamber within which the coupling capillary (43) slides and can move laterally according to user-specified tolerances, as one example only and without limitation, by approximately 1 mm. Sensor couplers have a low mass to insure that the initial coupling impulse of the face of optical fiber contacting the face of the annularizing fiber is sufficiently low that neither glass optical face is damaged. In some embodiments, without limitation, a coupler (43) has a mass of about 1.6 grams, but this amount can be larger or smaller as long as the initial coupling contact impulse does not damage either optical fiber face. In some embodiments, as the optical fiber (1) engages the coupler (43), the coupler (43) engages a spring mechanism (44) which gradually increases the coupling force between the optical fiber (1) and annularizing fiber (17) and maintains the optical fiber (1) face in close optical contact when the sensor cartridge is locked in place by tightening the clamp (45).

While the coupling mechanism herein described shows the optical fiber face engaging the sensor coupler, it is also permitted in some embodiments for the biosensor cartridge (9) to be first fully engaged in the cartridge mounting device without the optical fiber (1) contacting a coupler (43) and then, using mechanical controlled engagement means such but not limited to a dashpot, a low mass sensor coupler (43) is slowly lowered onto and engages with the protruding optical sensor fiber (1).

In some embodiments, without limitation, for a biosensor cartridge of about 2.1 mm in diameter, the inside diameter of the central hole in the biosensor clamp (45) and the fluid collet (42) is about 2.2 mm in diameter, which is approximately 0.1 mm in diameter larger than the diameter of the biosensor cartridge. Because of the interior length of the bore from the entrance of the biosensor clamp (45) through the fluid collet (42), the axial location of the sensor fiber is mechanically constrained to be within about 0.1 mm of the input hole of the sensor coupler (43).

Thus, in some embodiments, the coupling capillary “floats” in the x, y, and z axes and make itself axially and mechanically compliant with the sensor fiber being inserted. A long insertion bore is provided within the mounting body so that the biosensor cartridge sensor fiber passes through the fluid coupler without picking up residual fluids on its proximal face. In some embodiments, the long insertion bore centers the fiber as it enters the coupling capillary to better than about 1 mm. For this reason, some embodiments of the invention can comprise biosensor cartridges with shorter regions of fiber protruding from the proximal end.

Moreover, as the coupling capillary “floats” in the x, y and z axes, it auto-centers around the proximal face of the sensor fiber with the annularizer element to within 20 microns. Similarly, the “floating” accommodation by the low mass coupling capillary floats reduces shattering of the annularizing fiber as it contacts the sensor fiber during insertion; it is not until after the fiber has engaged the coupling capillary that the spring engages and applies a constant force to the junction. The annularizer sits in the low mass coupler and as the biosensor cartridge is inserted, the sensor fiber is more gently contacts the annularizer, moving the annularizer a small amount and thus engaging spring which applies additional accommodating contact force. Thus, as the desired optical coupling is realized, leak-free fluidic coupling also occurs, and by locking the sensor clamp, the biosensor cartridge is physically and operationally locked in place. Consequently, embodiments of the invention do not require the operator to move annularizers in and out of the coupler which protects their cladding from being destroyed by frequent insertions/removals.

As shown in FIG. 8, in accordance with some embodiments, a biosensor cartridge 9 is rapidly attached to the optical measurement apparatus by inserting the tubular biosensor cartridge through the bottom hole of a biosensor clamp (45) associated with the measurement instrument. In some embodiments, the diameter of the biosensor's fluid ferrule (37) and the external sheath (38) are approximately the same so that the fluid ferrule (37) is inserted into an inner bore of the mount until its fluid port (4) is contained within the fluid collet (41). At this point the biosensor clamp (45) may be screwed into the body (46), compressing the o-ring seals (40) in the fluid collet (41) and firmly locking the biosensor cartridge into the mount. This may be facilitated, as one example only and without limitation, by means of a lever (not shown) extending from the side of the biosensor clamp.

As the biosensor cartridge is inserted through the hole in the bottom of the biosensor clamp (45) and into a cylindrical bore in the body (46), having a diameter near to that of the fiber cartridge. Geometrical considerations constrain the position of the optical fiber (1) along the axis of the body (46), the proximal face of the optical fiber (1) protruding from the biosensor cartridge passes through the fluid coupler 42 without touching the fluid coupler (42) interior walls or residual drops of fluid left on said inside walls and enters the bottom hole in the coupling capillary (15) contained within a sensor coupler (43). As the biosensor cartridge insertion continues, the fiber 1 impinges upon a conical depression at the entrance to the sensor coupler thus forcing the sensor coupler previously unconstrained (“floating”) laterally, to conform its entrance hole to the center of the optical fiber (1) which then passes through the capillary hole until it intersects the face of the annularizing fiber (17). In some embodiments, the sensor coupler (43) is free to move vertically with minimal force and is thus configured to “float” the initial contact force of the sensor optical fiber against the face of the annularizing fiber and thus contact damage is minimized. As the biosensor continues to be inserted into the body (46), the optical fiber (1) face contacting the face of the annularizing fiber (17) held within the sensor coupler (43) pushes the sensor coupler (43) is pushed up against a spring (44) so as to provide a steady and reproducible force between the biosensor fiber (1) and the annularizing fiber (17).

In some embodiments, methods and elements other than or in addition to a fluid ferrule may be used to center the fiber and/or flow fluid into the chamber or flow channel. As some examples only and without limitation, molded plastic ribs in the biosensor cartridge may support the fiber, allowing the fiber to be centered and fluids to flow in the system. Alternatively, a molded spider may be usable.

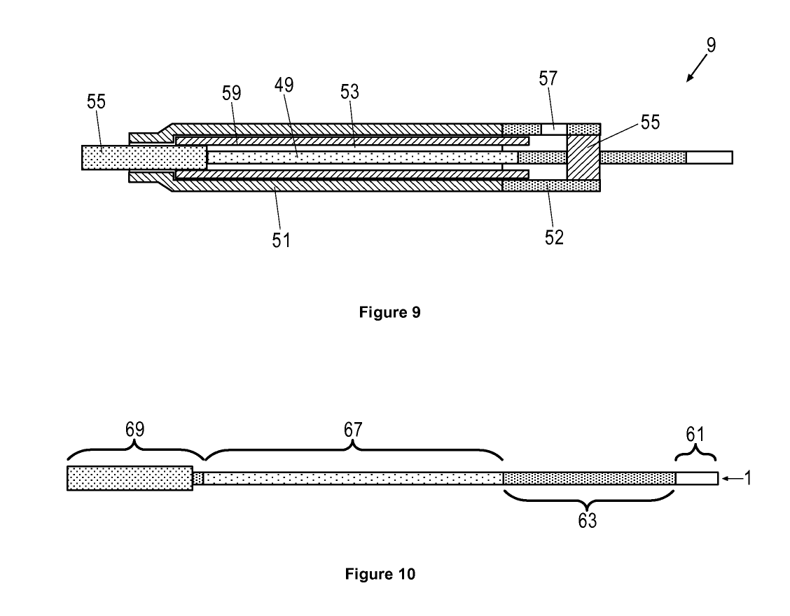

As shown in FIG. 9, in some embodiments, the biosensor cartridge (9) incorporates a sensitized fiber-optic segment (49) within a cartridge body (59) designed to allow fluids to be drawn into an inlet tube (55), past the sensitized region of optical fiber (49), and out through an outlet port (57) and finally into a liquid waste receptacle (not shown in FIG. 9). An inlet fluid port (55) is affixed in a leak-free manner to an outer sheath (59), such as a capillary tube, which will contain both the liquid sample and the sensitized optical fiber (49) when in use. The method of providing the leak tight seal may be accomplished by using glue, heat shrink tubing, or any other appropriate method known to those skilled in manufacturing arts for sealing an inlet tube (55) to a capillary tube (59). The capillary tube (59) is likewise sealed on the outlet side to a ferrule (52) which provides both egress for the optical fiber (49) and an outlet port (57) for drawing fluid through the cartridge (9). This ferrule (52) provides a method both by which the biosensor measurement instrument's holder firmly attaches to the biosensor cartridge (9) and by which a vacuum is applied to draw fluids into the inlet tube (55) and past the sensitized optical fiber (49) contained within the biosensor cartridge (9).

In some embodiments, the fiber-optic segment of the biosensor cartridge (9) is constructed from a single piece of Teflon-AF coated optical fiber (49) having four distinct regions. As shown in FIG. 10, a first proximal region (61) is clad in a low index of refraction polymer coating such as but not limited to Dupont Teflon AF® whose index of refraction closely matches that of the fluid which will pass through the biosensor cartridge (9). The proximal end of the biosensor (9) connects optically and/or physically to the biosensor measurement instrument. Portions of the proximal sheath covered fiber (49) may be in contact with the biological fluids within the biosensor cartridge (9) but do not provide a biochemical sensing surface. Other portions reside outside the cartridge and are used for attaching the biosensor cartridge (9) to the evanescent sensor measurement apparatus.

A second region (63) adjacent to the first proximal region (61) incorporates a second cladding over the low index of refraction cladding, which provides mechanical strength, protection from abrasion, and means for the sensor fiber (49) to be sealed with a plug (65) into the sensor cartridge ferrule (52).

A third region (67) adjacent to the second region (63) is substantially free of all polymer claddings and is chemically sensitized to bind fluorescently tagged reporting means to the sensitized surface of the fiber. That is, the third region has no Teflon-AF coating and is cleaned and chemically prepared and sensitized for use in sensing molecules present in the fluids, which pass through the biosensor cartridge in contact with its sensitized surface. The sensing surface is optically transparent and collects light radiation (e.g., fluorescence) which is emitted by fluorescently tagged molecules binding to the outside of the sensitized biosensor surface which are excited by light propagating within the fiber in such a way that its electrical field evanescently couples to the tagged molecules present on the chemically sensitized fiber surface. The sensing surface may be constructed to provide a fluorescent signal only when a tagged molecule binds to its surface, or the chemically sensitized surface may incorporate a small, but predetermined, number of fluorescent molecules which may be used for calibrating sensor performance and for compensating for batch to batch biosensor variation.

A fourth region (69) near the inlet tube (55) end of the biosensor (9) is covered in a sheath which prevents light escaping from the distal end of the biosensor fiber (49) from exciting fluorescently tagged reporting molecules, when used, in the surrounding solution. The distal end of the biosensor fiber (49) is covered by a protective sheath which is used to protect the Teflon AF coating on the distal end from damage and optionally to provide either a means for centering the biosensor fiber (49) within the biosensor cartridge (9) or for gluing and sealing the distal end of the biosensor fiber (49) within the biosensor cartridge (9).

Finally, for added strength, the capillary tube (59) may be surrounded by some strengthening means (not shown) such as but not limited shrink tubing or a close fitting plastic sheath.

In some embodiments, data is acquired from the biosensor in the following manner: Laser illumination is employed to produce a fluorescent signal indicative of binding of molecules to the surface of the biosensor. The light from a laser is distributed within the biosensor so that substantially all the light there propagates substantially at the “angle for total internal reflection.” This angle is determined by the index of refraction of the glass used to make the biosensor fiber and of the index of refraction of the solution surrounding the biosensor fiber.

In some embodiments, in order to facilitate the user's ability to perform routine biosensor measurements while minimizing efforts and possible errors, biosensor cartridges (9) and sample delivery elements are provided which allows sample, buffers, reagents, and calibrators to be sequentially drawn through the biosensor cartridge (9) without requiring a user to place vials containing such fluids at the biosensor cartridge's inlet port (55).

In performing a typical clinical assay using the biosensor cartridge, a variety of fluids are passed through the biosensor cartridge. These fluids may include a buffer to prepare and wet the biosensor surface, one or more calibrating solutions to calibrate the sensor, the biological sample containing labeled reagents or the biological sample by itself with no labeled reagents, and one or more labeled reagents. It may also be desirable to pass the biological sample placed into a sealed cartridge cavity through a membrane to strip blood cells and to mix the blood or serum with buffer or reagent. To accomplish this, the biosensor cartridge may possess a plurality of fluid channels and valving mechanisms. The number of each will be determined by number and order of the fluid transfer steps required for performing the assay on the cartridge. This will vary depending on the specific assay test implemented on the biosensor cartridge.

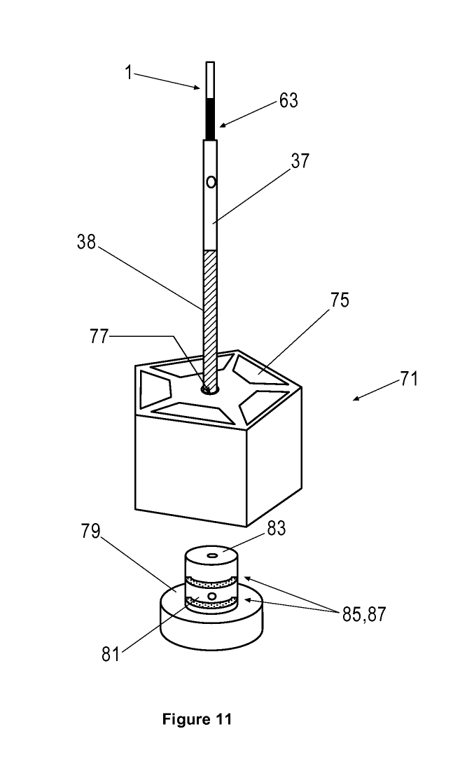

As shown in FIG. 11, in some embodiments, a sample holder/reagent pac (71) is provided which is comprised of a multi-well cup (73), either molded or machined, which is portioned into separate liquid holding regions (75) situated around a central core region (77) of the cup (73) through the top of which passes the fluid inlet port (55) of the biosensor cartridge (9). The cup (73) and/or holding regions may be covered or uncovered. The dimensions of the cups (75) may be so as to create a pac (73) which is short and wide compared to the taller sensor or it may be narrower and longer, extending upward to surround the sensor with what appears to be a tube as opposed to the flatter wider cup. The key feature is not the dimensional proportions of the cup, but rather the manner through which the reagents are directed into the sensor from the cups. The core (77) of this multi-well cup (73) is configured to enclose a rotating fluid selector (79) which provides fluid passage from a side-located fluid inlet port (81) and a top-located fluid outlet port (83) which mates with the biosensor cartridge's fluid inlet port (55). The biosensor-cartridge unit mates to the biosensor instrument (not shown) so that fluid selector (79) may be turned by a rotating mechanism such as and without limitation a stepper motor. By rotating said rotating fluid selector (79), the fluid outlet hole (not shown) of any fluid-containing well (75) may be aligned to the port input hole (81) of the rotating fluid selector (79), thus allowing fluid to be drawn up using a vacuum through the port to the sensor fiber (49), into the biosensor cartridge's fluid inlet port (55), and through a chamber (53) in the biosensor cartridge so that the fluid from the selected fluid-containing well (75) passes in intimate contact past the biosensor fiber (49) contained within the biosensor cartridge (9). By controlling the vacuum and by positioning the selector valve (79) either manually or using automatic positioning means, such as but not limited to a computer controlled positioning means, samples and fluids from different wells (75), in sequential or random order, may be drawn into the biosensor cartridge (9) and past the sensing surface of the biosensor fiber (49).

The sample holder/reagent pac (71) comprises one or more separate fluid holding regions (75) to hold the sample being measured as well as any reagents, wash solutions, or calibration solutions required for performing the biosensor assay. Some partitions may contain lyophilized, frozen or solid components that must be made liquid before a biosensor assay may be performed. Such liquefaction may be accomplished by thawing if the partition contains frozen material, and/or by the addition of a liquid from another well such as, but not limited to water, or a solution mixture appropriate for the assay being performed.

The rotating fluid selector (79) may comprise a first sealing means (85) which prevents fluids in one fluid holding region from mixing with fluids in other liquid holding regions. This may be accomplished by incorporating means which provide separate sealing areas or by the dimensions of and material used in making the rotating fluid selector (79) (i.e. a rotating press-fit seal). The rotating fluid selector (79) also may comprise a second sealing means (87) which prevents fluid from leaking from the connection between the biosensor cartridge's fluid inlet port (55) and the rotating fluid selector's outlet port (83). As one skilled in the art will appreciate, such means may be provided by, but are not limited to, using an O-ring seal between the biosensor cartridge's fluid inlet port (55) and the fluid output port (83) of the rotating fluid selector (79) or by a press fit between the biosensor cartridge's fluid inlet port (55) and the fluid output port (83) of the rotating fluid selector (79).

As shown in FIG. 12, after placing the cartridge (9) into the proper slot on the base of the measurement instrument (89), the biosensor cartridge (9) may be lowered into the sensor well such that the inlet tube (55) of the biosensor cartridge (9) is sealed to rotating fluid selector's outlet port (83) contained within the base of the sample holder/reagent pac (71), whose shape is keyed to the shape of the base receiving it. As the biosensor cartridge (9) is lowered, optionally, the rotating fluid selector (79), initially positioned so as to block its fluid inlet port (81), may be pushed slightly out of the multi-well chamber (71) so as both to align the port input hole (81) with the matching fluid output port (not shown) on a chamber well (75) and to engage with a mating connector which is connected to a computer controlled stepping motor (93) which is used to position the port input hole (81) on the selector valve (79) to the proper fluid chamber at each stage of the biosensor assay.

Control mechanisms (not shown) are provided to position the rotating fluid selector (79) at a known and desired point when each biosensor assay is performed. Such means may be provided by, but are not limited to, providing the sample holder/reagent pac with a unique shape which correctly mates with a holding base (91) in the biosensor measurement instrument (89), only when the sample holder/reagent pac (71) is inserted into the instrument (89) with a fixed orientation. By inserting the sample cup (71) at an initially known orientation, a slot or some other geometric shape located below the base of the rotating fluid selector (79) will engage with a rotating mating mechanism which can be positioned either manually or by automatic means to align the port in the rotating fluid selector (79) to the corresponding fluid outlet ports located at the bottom of each fluid containing partition (75).

Sample and fluid processing, application of the light source, and collection and processing of data from test runs are controlled electronically with systems and methods known to those of ordinary skill in the art. As some examples only, an associated microprocessor, which may integrate or be freestanding, is operably linked to a vacuum source, a pressure source, valving mechanisms, and/or a light source and programmed with control logic according to user preference. In such a system, the user may select and control the sequence, timing, duration, and/or nature of sample uptake, reagent use, application of light, vacuum, and pressure, and/or data collection and processing during a user-specified operation cycle.

Similarly, fluid distribution and movement during an operation cycle may be accomplished by alternative systems and methods in accordance with embodiments of the invention. As some examples only, fluid movement may be accomplished by selective application of vacuum from a vacuum source (not shown) using the fluid coupler (42); fluid movement may be obtained by application of pressure to reagent wells or cavities from a pressure source (not shown); fluid may be pushed by pressure from a pressure source (not shown) into the inlet tube (39) and out through the fluid port (4); or by any combination of these or other methods, according to user preference and suitable methods known to those of ordinary skill.

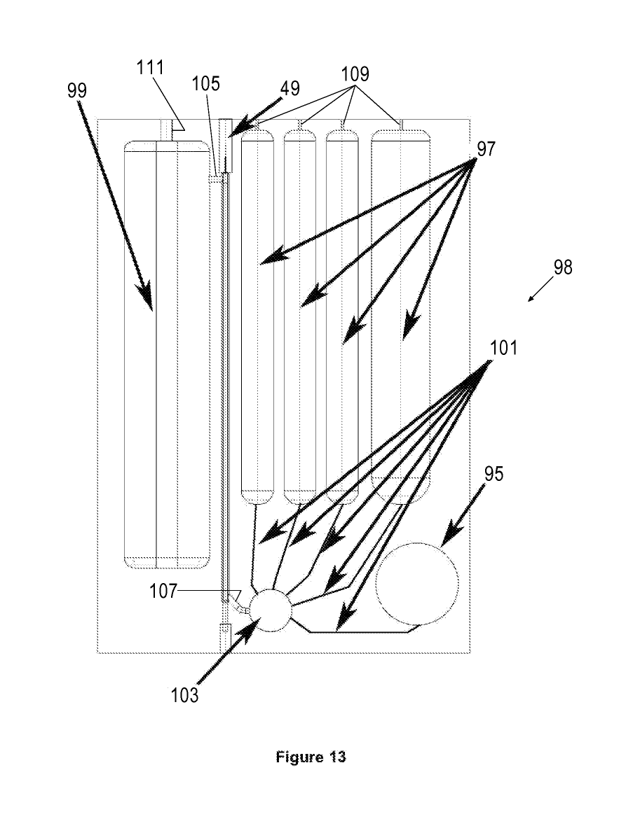

As shown in FIG. 13, in some embodiments, without limitation, an integrated biosensor cartridge (98) is provided, comprised of a flow channel (100) for the biosensor fiber (49) and a plurality of cavities for sample (95), reagents (97), and waste (99). The unitary biosensor may be formed by molding or by other suitable methods know to those of ordinary skill in the art. The flow channel may plastic or a co-molded glass or plastic capillary tube, or other suitable material according to the test being performed, the types of samples to be tested, and the nature of the reagents used. Reagents, as some examples only, buffers, calibrators, labeled antibodies, and the like, may be preloaded in respective cavities of the cartridge (98). Depending on user preference, labeled antibody reagents or calibrators may be preloaded as liquids, as frozen liquids in the cartridge which must be thawed before use, or as lyophilized reagents which must be reconstituted with water or buffer contained within the cartridge. Samples to be tested, as some examples only, the blood, urine, or other biological fluid, may be loaded into the respective sample cavity immediately before performing the sensing test. The cartridge may have one or more fluid channels (101) connecting a respective cavity with a valving mechanism (103), with the valving mechanism further connected to the flow channel (100) by its own fluid channel (107); however, a plurality of valving mechanisms can be used in some embodiments, in accordance with the user's preference and the intended function of the integrated biosensor cartridge. Suitable valving mechanisms are known to those or ordinary skill on the art and may include, as some examples only, rotary mechanisms, pin valves, magnetic flap valves, and/or flexible channel constriction. Selective fluid movement may be accomplished by application of pressure from a pressure source (not shown) to push fluids through the device (see, e.g., pressure connection channels (109) at the top of each reagent cavity), by using vacuum from a vacuum source (not shown) to pull reagents through the device (see vacuum application channel (111) at top of waste channel), or by any other suitable method or combinations thereof. Those of ordinary skill in the art will understand that certain adjustments to the configuration of the system might be necessary depending on the choice of fluid movement method, as one example only and without limitation, providing one or more reagent pressure ports with valves that open or close to atmosphere. Sample and fluid processing, application of the light source, and collection and processing of data from test runs may be controlled electronically as described previously herein.

### EXAMPLES

The following examples are provided without limiting embodiments of the invention to only the examples disclosed below and without disclaiming any other embodiments.

### Example 1

### Sandwich Immunoassay for Cardiac Troponin I

Drops of blood are dripped into a sample well on the surface of the cartridge and the well cover closed. The cartridge is locked into position in the measurement instrument with proper mating of the optical coupler, the stepper motor controlling the valve and the pump. Blood flows through an internal microchannels to one of the internal wells of the cartridge in a manner so that a measured amount of blood from the well is pumped into the internal well containing a buffering reagent. The measurement instrument then moves the valving selector so that a measured amount of buffer flows through the sensor at a rate of 20-100 μl/minute to establish a baseline reading. Readings from the sensor are recorded by the instrument for between 15-30 seconds. The selector valve moves to select fluid from a well containing a calibrator reagent. That calibrator reagent is pumped through the sensor over a period of 1.5-3.0 minutes at a rate of 20-100 μl/minute while the instrument records fluorescence as a function of time (seconds). As fluids pass through the sensor, they are deposited in the waste collection well. Data collection continues as the selector valve moves so as to interface with the buffer well and the pump speed is accelerated to 500-1000 μl per minute causing buffer to wash rapidly through the sensor for 5-30 seconds. The selector valve rotates so as to link the well containing blood through the sensor. No data is taken during this time. Cardiac troponin I is captured onto the surface of the fiber as the blood sample flows for 1.5-3 minutes. The selector valve again turns so as to interface with the buffer well and the pump speed is accelerated to 500-1000 μl per minute causing buffer to wash rapidly through the sensor for 5-30 seconds. The speed is reduced and buffer flows through the sensor at a rate of 20-100 μl/minute to establish a sample baseline reading. The selector valve turns to connect a reservoir containing fluorescent-labeled recognition reagent. This is pumped through the sensor over a period of 1.5-3.0 minutes at a rate of 20-100 μl/minute while the instrument records fluorescence as a function of time (seconds). The instrument continues to record fluorescence as the valve again turns so as to interface with the buffer well and the pump speed is accelerated to 500-1000 μl per minute causing buffer to wash rapidly through the sensor for 5-30 seconds.

A standard curve exists within the software of the instrument. The curve is based on correlation between the rate of fluorescence increase and the ratio between troponin I standards and the calibrator reagent. Software processes the instrument readings to generate the rate of fluorescence increase for both the calibrator and the recognition reagent following the sample. The ratio is correlated with the standard curve and a concentration of cardiac troponin I is reported on the instrument display.

### Example 2

### Competitive Immunoassay for Estrone-3-Glucuronide

Urine is poured into a sample well and the cartridge is mounted as described above. A metered amount of urine is pumped into a well containing recognition reagent. The pump mixes the urine sample and recognition reagent by pulsatile pumping. The instrument then turns the selector valve so that a measured amount of buffer flows through the sensor at a rate of 20-100 μl/minute to establish a baseline reading. Readings from the sensor are recorded by the instrument for between 15-30 seconds. The selector valve moves to a well containing recognition reagent. That reagent is pumped through the sensor over a period of 1.5-3.0 minutes at a rate of 20-100 μl/minute while the instrument records fluorescence as a function of time (seconds). Data collection continues as the selector valve turns so as to interface with the buffer well and the pump speed is accelerated to 500-1000 μl per minute causing buffer to wash rapidly through the sensor for 5-30 seconds. The valve rotates so as to link the well containing urine+fluorescent recognition reagent through the sensor. This is pumped through the sensor over a period of 1.5-3.0 minutes at a rate of 20-100 μl/minute while the instrument records fluorescence as a function of time (seconds). The instrument continues to record fluorescence as the selector valve again turns so as to interface with the buffer well and the pump speed is accelerated to 500-1000 μl per minute causing buffer to wash rapidly through the sensor for 5-30 seconds. The rate of fluorescence increase seen with the recognition reagent plus urine is divided by that seen with just the recognition reagent. The ratio is correlated with an imbedded standard curve and concentration is reported on the instrument display.

### Example 3

### Assay of Either Type where Cells Must be Separated from Serum Prior to Performing the Assay

A blood sample is applied to a sample the well and the cover of the cartridge well is closed. As blood flows through the internal channel, a measured amount is directed into a second channel in which is deposited a medium (such as and without limitation Cellex) which stops cells from passing but permits serum to pass. Pressure is applied to a second cavity containing buffer. This cavity is connected to the second channel so that the pressure pushes the blood serum through the medium and into a sample well. Other subsequent operations ensue as described previously.

This application may reference various publications by author, citation, and/or by patent number, including without limitation, articles, presentations, and United States patents. The disclosures of each of these references are hereby incorporated by reference in their entireties into this application.

The preceding description has been presented only to illustrate and describe exemplary embodiments of apparatus, systems, and methods of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. This description of the invention should be understood to include all novel and non-obvious combinations of elements described herein, and claims may be present in this or a later application to any novel and non-obvious combination of these elements or any equivalents. The foregoing embodiments are illustrative, and no single feature or element is essential to all possible combinations that may be claimed in this or a later application. The invention may be practiced otherwise than is specifically explained and illustrated without departing from its spirit or scope. The scope of the invention is limited solely by the following claims.

1. A biosensor cartridge comprising:
an optical fiber disposed at least in part within a flow channel, forming a chamber between an outer surface of the optical fiber and an internal surface of the flow channel;
a proximal end coupling region configured to couple the optical fiber to a an evanescent sensing measurement apparatus having annularizing illumination elements;
a fluid ferrule joined to the proximal end of the flow channel; and
an inlet tube joined to the distal end of the optical fiber and to the internal surface at the distal end of the flow channel,
wherein the optical fiber has a proximal end support region and a distal end support region each comprising a low index cladding disposed in a protective sheath, and a chemically sensitized region free of such cladding which is disposed between the proximal end support region and the distal end support region,
the proximal end support region is disposed at least in part within the fluid ferrule,
the inlet tube is configured to center the optical fiber within the flow channel, and the inlet tube and the fluid ferrule are configured to allow one or more liquids to be drawn up through the inlet tube, the chamber, and the fluid ferrule.

2. The biosensor cartridge of claim 1, wherein the evanescent sensing measurement apparatus comprises a fluid control system and wherein the proximal end of the cartridge is configured to engage a receptacle on the evanescent sensing measurement apparatus, connect the fluid ferrule to the fluid control system, and couple the proximal end of the optical fiber to the annular illumination elements of the evanescent sensing measurement apparatus.

3. The biosensor cartridge of claim 1, further comprised of an external sheath surrounding at least a portion of the flow channel.

4. The biosensor cartridge of claim 1, wherein the flow channel is a glass capillary tube.

5. The biosensor cartridge of claim 1, wherein the proximal end of the cartridge is configured to couple with the annularizing illumination elements through a mechanically compliant optical butt-coupling mechanism.

6. The biosensor of claim 1, wherein at least one of the liquids is a biological liquid.

7. A biosensor cartridge system comprised of:
a cylindrical cartridge comprised of a plurality of cavities for containing fluids surrounding a central open core, each of the cavities having an outlet port;
a selector valve having an inlet port and an outlet port, and
a biosensor cartridge according to claim 1,
wherein the distal inlet tube of the biosensor cartridge is configured to insert within the central open core of the generally cylindrical cartridge and connect to the outlet port of the selector valve, the input port of the selector valve further configured to communicate selectively by its input port with any of the outlet ports of the cavities.

8. The biosensor cartridge system of claim 7, wherein the selective communication of the inlet port of the selector valve is controlled by a microprocessor.

9. The biosensor cartridge system of claim 7, wherein the proximal end of the cartridge of claim 1 is configured to couple with the annularizing illumination elements through a mechanically compliant optical butt-coupling mechanism.

10. The biosensor cartridge system of claim 7, further comprised of an external sheath surrounding at least a portion of the flow channel.

11. The biosensor cartridge system of claim 7, wherein the flow channel is a glass capillary tube.

12. The biosensor cartridge system of claim 7, wherein at least one of the fluids is a biological fluid.

13. An integrated biosensor cartridge comprised of:
a flow channel containing a chemical sensitized region of an optic fiber configured to couple to annularizing illumination elements of an evanescent sensing measurement apparatus,
one or more valving mechanisms selectively in fluid communication with the flow channel, and
a plurality of cavities for containing fluids which are selectively in fluid communication with one or more of the valving mechanisms.

14. The integrated biosensor cartridge of claim 13, wherein the evanescent sensing measurement apparatus comprises a fluid control system and wherein the proximal end of the optical fiber is configured to engage a receptacle on the evanescent sensing measurement apparatus and couple to the annular illumination elements.

15. The integrated biosensor cartridge of claim 13, wherein the proximal end of the optical fiber is configured to couple with the annularizing illumination elements through a mechanically compliant optical butt-coupling mechanism.

16. The integrated biosensor cartridge of claim 13, wherein the selective communication of one or more valving mechanisms with the flow channel and of the plurality of cavities for containing fluids with one or more of the valving mechanisms is controlled by a microprocessor.

17. The integrated biosensor cartridge of claim 13, wherein at least one of the fluids is a biological fluid.

18. A system for measuring an analyte in a sample, comprising:
an evanescent sensing measurement apparatus with annularizing illumination elements;
a biosensor cartridge comprised of:
an optical fiber disposed at least in part within a flow channel, forming a chamber between an outer surface of the optical fiber and an internal surface of the flow channel;
a proximal end coupling region configured to couple the optical fiber to a an evanescent sensing measurement apparatus having annularizing illumination elements;
a first fluid port joined to the proximal end of the flow channel; and
a second fluid port joined to the distal end of the optical fiber and to the internal surface at the distal end of the flow channel,
wherein the optical fiber has a proximal end support region and a distal end support region each comprising a low index cladding disposed in a protective sheath, and a chemically sensitized region free of such cladding which is disposed between the proximal end support region and the distal end support region,
the proximal end support region configured to center the optical fiber within the flow channel is disposed at least in part adjacent to the first fluid port,
the distal end support region also configured to center the optical fiber within the flow channel,
the first fluid port and the second fluid port are configured to allow liquid to be drawn up through the first fluid port, the chamber, and the second fluid port;
one or more valving mechanisms selectively in fluid communication with the flow channel; and
a plurality of cavities for containing fluids which are selectively in fluid communication with one or more of the valving mechanisms,
wherein the selective communication of one or more valving mechanisms with the flow channel and of the plurality of cavities for containing fluids with one or more of the valving mechanisms is controlled by a microprocessor.

19. The system of claim 18, wherein the evanescent sensing measurement apparatus comprises a fluid control system and wherein one or more fluid ports connected to one or more fluid channels within the cartridge are configured to engage fluid control ports of the evanescent sensing measurement apparatus fluid control system, and to couple the proximal end of the optical fiber to the annular illumination elements of the evanescent sensing measurement apparatus.

20. The system of claim 18, wherein the biosensor cartridge is further comprised of an external sheath surrounding at least a portion of the flow channel.

21. The system of claim 18, wherein the flow channel is a glass capillary tube.

22. The system of claim 18, wherein the proximal end of the biosensor cartridge is configured to couple with the annularizing illumination elements through a mechanically compliant optical butt-coupling mechanism.

23. The system of claim 18, wherein the sample is a biological sample.

24. The system of claim 18, wherein the proximal end of the biosensor cartridge is configured to couple with the annularizing illumination elements through a mechanically compliant optical coupling mechanism.

25. The system of claim 18, wherein the biosensor cartridge is comprised of printed, embedded, or attached control information readable by a control program of the microprocessor.

26. The system of claim 24, wherein the sample is a biological sample.
